(19) United States
(12) Patent Application Publication
(10) Pub. No.: US 2018/0126503 A1
(43) Pub. Date: May 10, 2018

(54) Manufacturing Of Multi-Degree-Of-Freedom Precise Stage Comprising Multi-Materials And Using Three-Dimensional Printer

(71) Applicant: Industry-University Cooperation Foundation Hanyang University ERICA Campus, Ansan-si, Gyeonggi-do (KR)

(72) Inventors: Dong Hyeok Lee, Ansan-si, Gyeonggi-do (KR); Nahm Gyoo Cho, Ansan-si, Gyeonggi-do (KR)

(21) Appl. No.: 15/569,021

(22) PCT Filed: Jun. 23, 2015
(86) PCT No.: PCT/KR2015/006346

§ 371 Date: Oct. 24, 2017

(30) Foreign Application Priority Data
Apr. 24, 2015 (KR) 10-2015-0057923

(51) Int. Cl. B23Q 1/36; B29C 67/24; B33Y 30/00; B33Y 50/02; B33Y 70/00

(52) U.S. Cl. CPC B23Q 1/36; B29C 67/24; B23Q 2210/002; B33Y 50/02; B33Y 70/00; B33Y 30/00

(57) ABSTRACT

Disclosed is a multi-degree-of-freedom precise stage comprising multi-materials and using a three-dimensional printer. A multi-degree-of-freedom precise stage device comprises: a flexure hinge provided as a coupling element between an outer frame and a stage moving part; and a plurality of piezoelectric actuators provided at the outer frame so as to move a stage by the degrees of movement-freedom in multiple directions, and the stage, which has a monolithic structure, is manufactured from at least two materials having different material properties by using the three-dimensional printer.

### TECHNICAL FIELD

The present invention relates to a technology for fabricating a multi-degree-of-freedom precision stage.

### BACKGROUND ART

The need for a superprecision positioning apparatus is increasing in fields, such as precise measurement, semiconductor manufacturing equipment and superprecision processing machines. Many superprecision stages use flexure hinges and piezoelectric actuators in order to maintain high precision and repetition. The flexure hinge includes a stage and a single body and has an advantage of providing a smooth and continuous movement because transfer is performed using the elastic deformation of hinge materials. Furthermore, the piezoelectric actuator is widely used in the positioning apparatus due to advantages, such as high position resolution, high productivity, fast response speed and an easy reduction of the size. Accordingly, research regarding a technology for designing and fabricating a multi-degree-of-freedom superprecision stage by combining the flexure hinge and the piezoelectric actuator is actively carried out so far.

Recently, the application field of the 3D printer is rapidly expanded due to advantages of the 3D printer and technological development thereof. Various processes are developed due to a lot of research and development regarding the 3D printer and rapid prototyping, processing precision is improved, and costs for equipment are reduced. A process for the rapid prototyping is very various, but has the same concept of processing a 3D shape by stacking a thin layer. Such a process has a great advantage in the processing of a complicated shape that is difficult to process using precision machine tools, such as a computerized numerical control lathe and a milling machine, and conventional processing methods, such as wire-cut electrical discharge machining, and that requires a lot of time and lots of costs. Accordingly, the 3D printer is being used in various fields, such as a mold, a robot and bio engineering (e.g., a human ear), in addition to the fabrication of a prototype model using the 3D printer.

### DISCLOSURE

### Technical Problem

There is provided a technology for fabricating a multi-degree-of-freedom precision stage of a flexure hinge structure made of two or more materials using a 3D printer.

There is provided a technology for fabricating a multi-degree-of-freedom precision stage capable of configuring a multi-material monolithic structure that is difficult to fabricate using a conventional processing method by fabricating the stage of the monolithic structure using different materials through a 3D printer having a dual nozzle.

### Technical Solution

There is provided a multi-degree-of-freedom precision stage apparatus, including a flexure hinge configured as a coupling element between an external frame and a stage moving part and a plurality of piezoelectric actuators disposed in the external frame, for moving the stage with a moving degree of freedom in a plurality of directions, wherein the stage of a monolithic structure is fabricated using two or more materials having different physical properties using a 3D printer.

In accordance with one aspect, a first material having a first physical property may be used in the structure of the flexure hinge, and a second material having a second physical property stiffer than the first physical property may be used in the rubber structure of the stage.

In accordance with another aspect, a nylon filament may be used in the structure of the flexure hinge, and a polylactic acid (PLA) filament may be used in the rubber structure of the stage.

In accordance with yet another aspect, metal or an alloy using at least one of aluminum (Al), titanium (Ti) and copper (Cu) may be used in the structure of the flexure hinge, and metal or an alloy using at least one of magnesium (Mg), iron and steel may be used in the rubber structure of the stage.

In accordance with yet another aspect, the flexure hinge may be configured in a hinge form including a leaf spring and a notch.

In accordance with yet another aspect, the flexure hinge may be configured in a hinge form including a leaf spring of a nylon filament and a notch of a polylactic acid (PLA) filament.

In accordance with yet another aspect, the 3D printer may include a printer of a fused deposition modeling (FMD) method capable of outputting different materials.

In accordance with yet another aspect, a displacement sensor disposed in the external frame, for measuring a displacement for a moving direction of the stage may be further included.

In accordance with yet another aspect, the displacement sensor may include a capacitive sensor disposed in accordance with the piezoelectric actuator.

There is provided a method of fabricating a multi-degree-of-freedom precision stage, wherein the multi-degree-of-freedom precision stage includes including a flexure hinge configured as a coupling element between an external frame and a stage moving part and a plurality of piezoelectric actuators disposed in the external frame, for moving the stage with a moving degree of freedom in a plurality of directions, and the method of fabricating the multi-degree-of-freedom precision stage includes fabricating the stage of a monolithic structure using a multi-material output by a 3D printer by controlling the 3D printer outputting two or more different materials based on a 3D design for the multi-degree-of-freedom precision stage.

### Advantageous Effects

In accordance with an embodiment of the present invention, a new stage can be fabricated and a more flexible design is possible in the design of a multi-degree-of-freedom precision stage because the parallel lever structure and flexure hinge structure of the stage are fabricated using materials having different physical properties using the 3D printer.

Accordingly, the stress of a hinge part at which maximum stress is generated can be reduced, and the selection of a piezoelectric element and a reduction in the size of the stage can be facilitated because a force necessary to drive the stage can be reduced.

### DESCRIPTION OF DRAWINGS

FIG. 1 is a diagram for illustrating the structure of a multi-degree-of-freedom precision stage made of a multi-material in an embodiment of the present invention.

FIG. 2 shows the results of a stress distribution of a stage having a multi-material monolithic structure in an embodiment of the present invention.

FIG. 3 shows the results of the deformation of a stage having a multi-material monolithic structure in an embodiment of the present invention.

FIG. 4 shows a system for driving the multi-degree-of-freedom precision stage made of a multi-material in an embodiment of the present invention.

FIGS. 5 and 6 show systems for measuring resolution of the multi-degree-of-freedom precision stage made of a multi-material in an embodiment of the present invention.

### BEST MODE FOR INVENTION

Hereinafter, embodiments of the present invention are described in detail with reference to the accompanying drawings.

The present embodiments relate to a technology for fabricating a multi-degree-of-freedom precision stage and, more particularly, to a technology for fabricating a multi-degree-of-freedom precision stage of a flexure hinge structure using materials having different physical properties using a 3D printer.

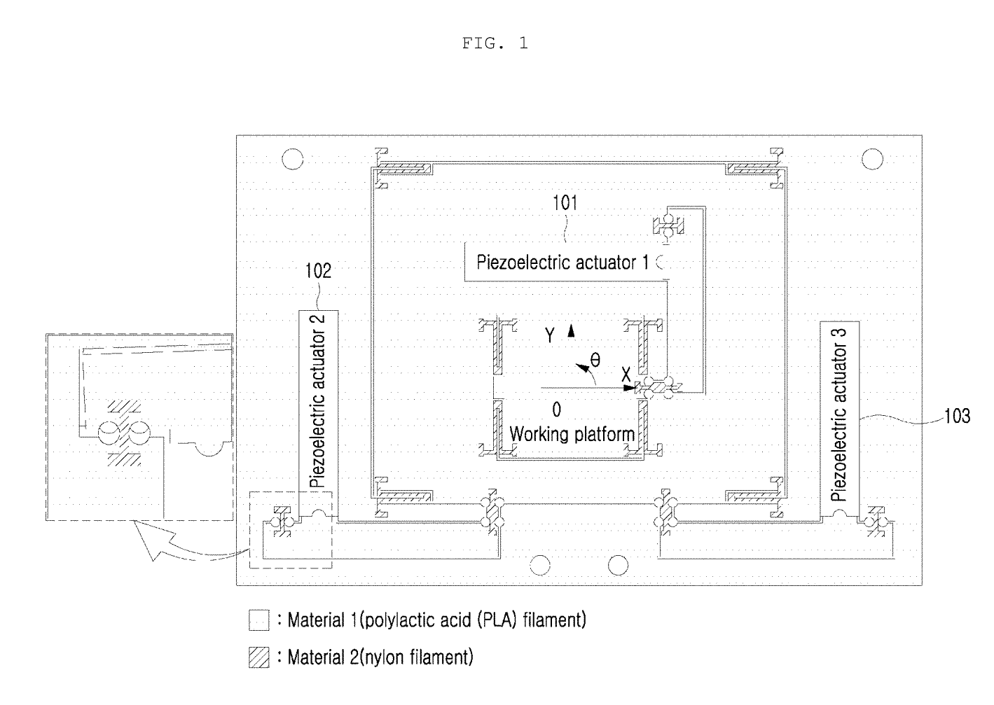

FIG. 1 is a diagram for illustrating one form of a 3-degree-of-freedom precision stage in an embodiment of the present invention.

FIG. 1 illustrates a 3-degree-of-freedom precision stage 100 having the entire size of 200 mm (length)×130 mm (breadth)×10 mm (thickness). The 3-degree-of-freedom precision stage 100 has been fabricated to move by attaching three piezoelectric actuators 101, 102 and 103 to an external frame for configuring the stage.

The first piezoelectric actuator 101 is configured to operate in the X axis direction and may mechanically amplify a transfer range in the X axis direction. Furthermore, the second and the third piezoelectric actuators 102 and 103 are designed in a Y-axis symmetrical form. The second and the third two piezoelectric actuators are configured to be transferred in the Y-axis direction when they move in the same direction at the same time and to rotate in a 0-axis direction when they move in different directions.

A flexure hinge is a coupling element between the external frame and a stage moving part and has a monolithic structure. The flexure permits only a flexure movement in one direction and has strong stiffness for a movement in the other direction. In general, such a form includes a hinge form having a leaf spring and a notch.

The present invention is to configure the flexure hinge using two materials having different physical properties. For example, a polylactic acid (PLA) filament is used in portions that require strong stiffness, such as the external frame and a lever. Furthermore, a nylon filament that is more flexible and has better elasticity is used in the flexure hinge and a spring portion. In particular, a leaf spring hinge of a nylon material is smoothly bent in the central part of the flexure hinge, and a notch hinge of a harder PLA material is configured outside the flexure hinge so that stress is concentrated on the center of rotation. It is expected that the two materials form the monolithic structure by heat while being output by the 3D printer, but they may be designed to widen the contact surface of the two materials and to add a mechanical combination lock in order to improve a failure when fabrication is performed or durability.

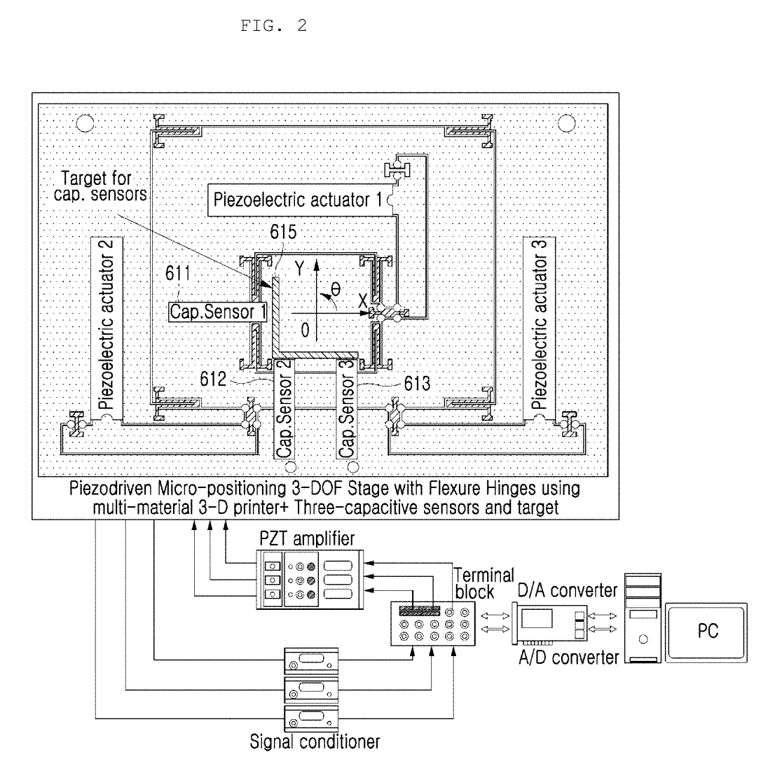

Table 1 shows the results of finite element analysis of three stages in PLA frames having flexure hinges of (1) material: aluminum (Al 7075-T6), (2) material: PLA, and (3) material: nylon material according to the designed dimensions. FIG. 2 shows the results of analysis of the flexure hinge structure made of materials having different physical properties according to the present invention.

TABLE 1

| | | 1^{st} Natural |
|---|---|---|
| Displacement [μm] | Maximum stress [MPa] | frequency [Hz] |
| 237.41 | 149.46 | 357.8 |
| 234.48 | 4.89 | 59.8 |
| 232.82 | 2.87 | 54.7 |

The results of Table 1 and FIG. 2 include the output displacement of an end-pointer, maximum stress in the entire area of the stage, and a natural frequency when 60 μm, that is, a maximum displacement of the piezoelectric actuator, is applied.

It may be seen that the three materials have similar displacements. The lever ratios of the three materials are similar; (1) material is 3.95, (2) material is 3.91 and (3) material is 3.88 with respect to the 60 μm input. In contrast, it may be seen that the maximum stress in the flexure hinge part has a difference of a maximum of about 52 times between (1) material and (3) material.

If the stage of the multi-material monolithic structure proposed by the present invention is used, the stage may be driven using a small force compared to the existing aluminum stage. Accordingly, the selection of the piezoelectric actuator is easy and a reduction in the size is possible.

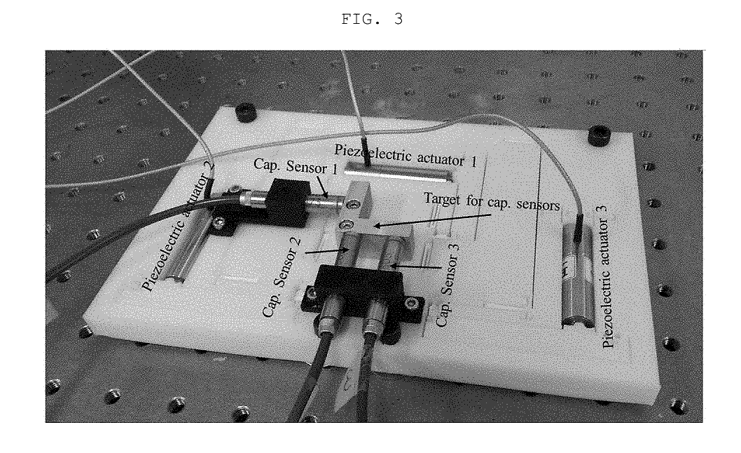

In addition, as the results of the execution of finite element analysis in the driving directions of the designed stage using the same method, deformation in each of the driving directions for the input displacement of 60 μm is shown in FIG. 3. It is estimated that the entire task area of the stage of the multi-material monolithic structure according to the present invention is a maximum of about 233 μm×233 μm in the X axis and the Y-axis direction and a maximum of ±1000 arcsec in the θ-axis direction.

The 3D printer is equipment for fabricating a 3D stereoscopic matter by stacking materials, such as a polymer (resin) and metal of a liquid and/or powder form, using a processing/stacking method (layer-by-layer) based on design data through rapid prototyping (RP). A complicated shape whose inside is empty, such as a honeycomb structure, can be implemented in a short time if a 3D drawing file is present, thereby being capable of overcoming a structural limit when a precision stage is designed. Accordingly, a stage design of a new form is possible by applying various mechanical structures and design schemes.

In the present invention, the PLA acid filament is used in portions that require strong stiffness, such as the external frame and the lever. The nylon filament that is more flexible and has better elasticity is in the flexure hinge and the spring portion. In the present invention, the multi-degree-of-freedom precision stage of a monolithic structure can be fabricated using a multi-material having different physical properties using a 3D printer.

For example, a cheap fused deposition modeling (FDM) 3D printer may be used as the 3D printer. The FDM method has lower surface quality than other methods, but can output different materials at the same time at different temperatures. A minimum stacking thickness of the 3D printer used for the stage fabrication is 50 μm.

In the existing precision stage, fabrication is chiefly performed using precision machine tools, such as a computerized numerical control lathe and a milling machine, and a wire-cut electrical discharge machine. Such conventional machine processing requires a lot of time and money because an aluminum block is processed while it is cut using a tool.

In contrast, the 3D printer can reduce a production cost and time due to a simplified fabrication process, and enables rapid research and development because the design can be modified and supplemented in real time if there is a 3D design. The monolithic structure may be fabricated without a process of assembling two or more materials. Accordingly, an error or failure which may occur in the assembly process can be reduced. Stages of cheap and various structures may be fabricated more rapidly by applying the advantages of the 3D printer to the fabrication of a precision stage.

In a multi-material structure applied to the 3-degree-of-freedom stage, different elasticity and stiffness from among the physical properties of materials are chiefly used. If a metal material is used, a 3D printing prototyping method includes multi-metal parts using a direct metal tooling (DMT) method. For example, metal or an alloy using aluminum (Al), titanium (Ti) or copper (Cu) that is a flexible material and has relatively better elasticity may be used for the flexure hinge part. Metal or an alloy, such as magnesium (Mg), iron or steel-series that is a brittle material and has relatively better strength may be used for the external frame. The external frame of the precision stage using the existing flexure hinge can be thinly fabricated, and the capacity of the piezoelectric actuator is reduced. Accordingly, a precision stage having the same driving range and that is small and cheap can be fabricated.

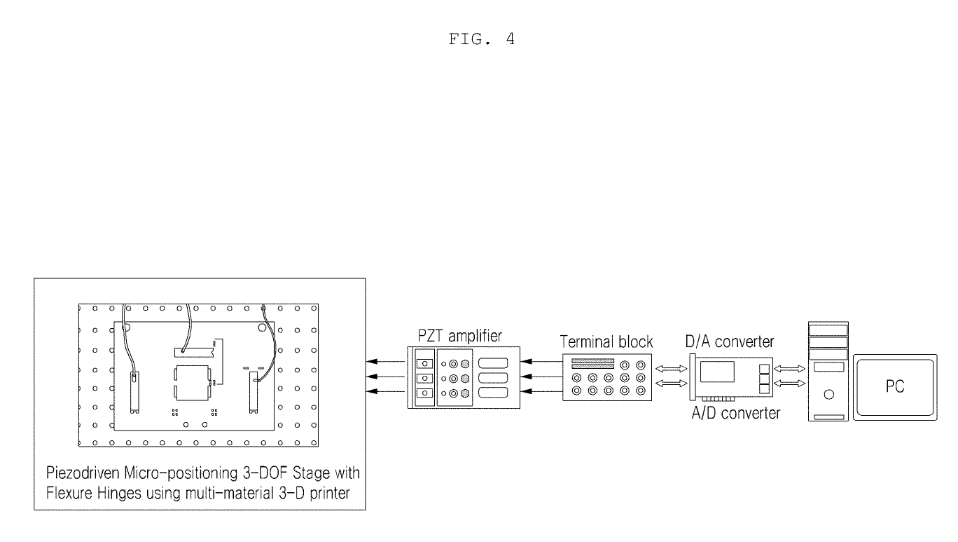

In the present invention, the 3-degree-of-freedom stage of a multi-material monolithic structure designed using an analysis model and finite element analysis may be fabricated using the 3D printer. The constructed system for driving the 3-degree-of-freedom stage is shown in FIG. 4. Furthermore, performance of the constructed stage may be checked through experiments.

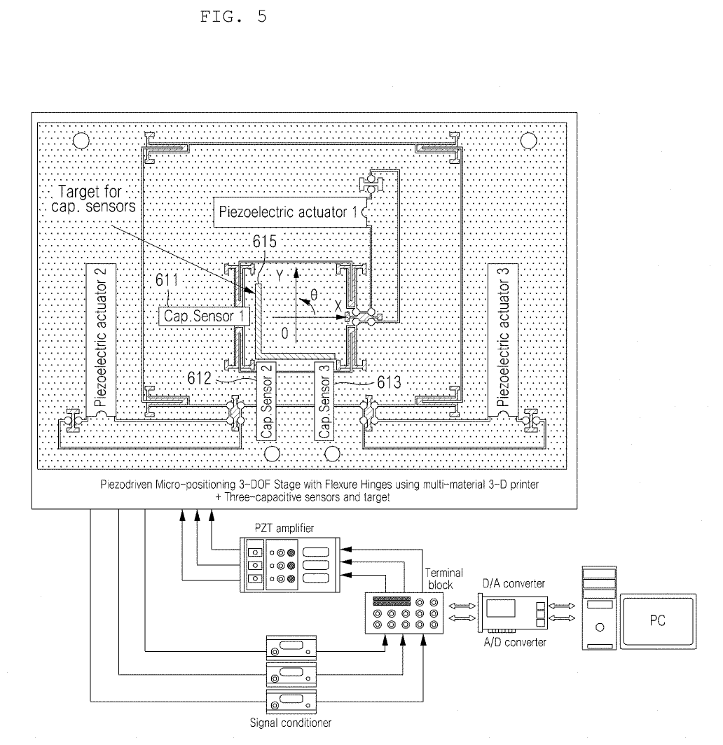

First, resolution of the stage fabricated using a high-resolution capacitive sensor (ADE technologies, 4810 gauging instrument and 2805 probe) may be seen. For example, as shown in FIG. 5, three capacitive sensors 611, 612 and 613 and a target capacitive sensor 615 may be disposed in the frame in which the three piezoelectric actuators have been disposed, and displacements in the X axis, Y axis and θ axis may be measured. In this case, the first capacitive sensor 611 may be configured to measure the displacement in the X-axis direction. Furthermore, the second and the third capacitive sensors 612 and 613 are designed in a Y-axis symmetrical form, and may be configured to measure the displacements in the Y-axis and θ-axis directions using two sensor values. The disposed capacitive sensors 611, 612, 613 and 615 have a measuring range of 100 μm and measurement resolution of 0.5 nm.

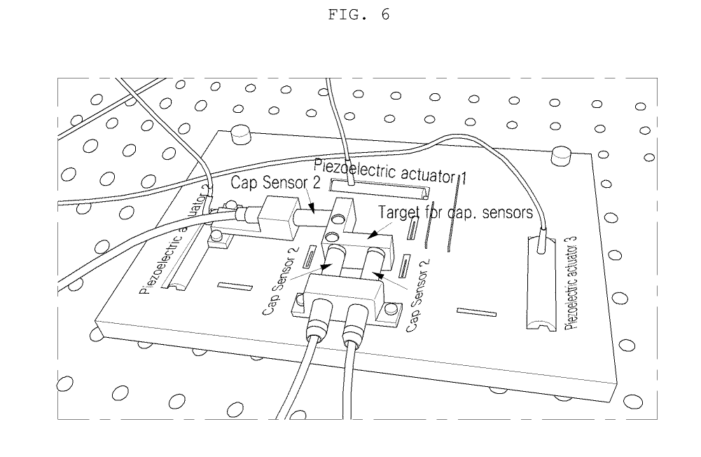

FIG. 6 shows a stage experiment environment using the capacitive sensors. The mechanical lever ratio, hysteresis and resolution of the stage to which the fabrication technology of the present invention has been applied may be evaluated within the range where measurement may be performed using the capacitive sensors. In order to measure the lever ratio, the output of an end-effector according to the input of the piezoelectric actuator in the driving direction may be obtained as the output of the capacitive sensors 611, 612, 613 and 615.

Furthermore, in order to measure the lever ratio of the full-scale operating range for the multi-degree-of-freedom precision stage made of the multi-material, a multi-degree-of-freedom vision measuring instrument using a camera and a reference image may be constructed.

A method of fabricating the multi-degree-of-freedom precision stage according to the present invention may include more shortened operations or added operations based on the detailed contents of the stage fabrication system described through FIGS. 1 to 6. Furthermore, two or more operations may be combined and the sequence or location of the operations may be changed. For example, the method of fabricating the multi-degree-of-freedom precision stage according to the present invention may include the step of fabricating the stage of the monolithic structure using the multi-material output by the 3D printer by controlling the 3D printer that outputs two or more different materials based on the 3D design of the multi-degree-of-freedom precision stage.

As described above, in accordance with the embodiments of the present invention, an application to a precision positioning apparatus is possible by fabricating the 3-degree-of-freedom flexure hinge stage made of two or more materials using the 3D printer. The stage of the monolithic structure can be fabricated using different materials using the 3D printer having a dual nozzle, and the multi-material monolithic structure that is difficult to fabricate using a conventional processing method can be configured. Furthermore, the stress of a flexure hinge part at which maximum stress is generated can be reduced because a more flexible design is possible in the design of the multi-degree-of-freedom precision stage using materials having different physical properties. In order to check performance of the fabricated stage, the multi-degree-of-freedom measurement system using the capacitive sensors can be constructed, and the lever ratio, hysteresis and resolution can be evaluated using the system. Furthermore, in order to measure the lever ratio of the full-scale operating range, the multi-degree-of-freedom vision measuring instrument using a camera and a reference image can be constructed. Furthermore, in the case of a multi-degree-of-freedom flexure hinge stage using the 3D printer of the multi-material, the selection of a piezoelectric element is facilitated and the size of the stage can be reduced because a force necessary to drive the stage is reduced. It is expected that the present invention may be used to research and develop a precision stage a lot because the stage can be developed rapidly and with low costs. Accordingly, stages of new forms and various structures that generate a high amplification ratio may be fabricated by further utilizing the advantages of the 3D printer.

The methods according to the embodiments of the present invention may be implemented in the form of a program instruction capable of being executed through various computer systems and may be recorded on a computer-readable medium.

The apparatus described above may be implemented in the form of a hardware element, a software element and/or a combination of a hardware element and a software element. For example, the apparatus and elements described in the embodiments may be implemented using one or more general-purpose computers or special-purpose computers, for example, a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processing apparatus may perform an operating system (OS) and one or more software applications executed on the OS. Furthermore, the processing apparatus may access, store, manipulate, process and generate data in response to the execution of software. For convenience of understanding, one processing apparatus may have been illustrated as being used, but a person having ordinary skill in the art may understand that the processing apparatus may include a plurality of processing elements and/or a plurality of types of processing elements. For example, the processing apparatus may include a plurality of processors or a single processor and a single controller. Furthermore, other processing configurations, such as a parallel processor, are also possible.

The software may include a computer program, code, an instruction or a combination of one or more of them, and may configure the processing device so that it operates as desired or may instruct the processing apparatus independently or collectively. The software and/or data may be embodied in any type of a machine, component, physical device, virtual equipment, computer storage medium, device or a transmitted signal wave permanently or temporarily in order to be interpreted by the processing apparatus or to provide an instruction or data to the processing apparatus. The software may be distributed to computer systems connected over a network and may be stored or executed in a distributed manner. The software and data may be stored in one or more computer-readable recording media.

The methods according to the embodiments may be implemented in the form of a program instruction executable through various computer means and stored in a computer-readable recording medium. The computer-readable recording medium may include a program instruction, a data file and a data structure solely or in combination. The program instruction recorded on the medium may have been specially designed and configured for the embodiments or may be known and available to those skilled in the computer software. The computer-readable recording medium includes, for example, magnetic media such as a hard disk, a floppy disk and a magnetic tape, optical media such as CD-ROM or a DVD, magneto-optical media such as a floptical disk, and a hardware device specially configured to store and execute the program instruction such as ROM, RAM and flash memory. Examples of the program instruction may include high-level language code executable by a computer using an interpreter in addition to machine language code such as code written by a compiler. The hardware device may be configured in the form of one or more software modules in order to perform the operations of the embodiments, and the vice versa.

### MODE FOR INVENTION

As described above, although the embodiments have been described in connection with the limited embodiments and the drawings, a person having ordinary skill in the art may modify and change the embodiments in various ways from the description. For example, proper results may be achieved although the aforementioned descriptions are performed in order different from that of the described method and/or the aforementioned elements, such as the system, configuration, device and circuit, are coupled or combined in a form different from that of the described method or replaced or substituted with other elements or equivalents.

Accordingly, other implementations, other embodiments, and the equivalents of the claims belong to the scope of the claims.

1. A multi-degree-of-freedom precision stage apparatus, comprising:
a flexure hinge configured as a coupling element between an external frame and a stage moving part; and
a plurality of piezoelectric actuators disposed in the external frame, for moving the stage with a moving degree of freedom in a plurality of directions,
wherein the stage of a monolithic structure is fabricated using two or more materials having different physical properties using a 3D printer.

2. The stage apparatus of claim 1, wherein:
a first material having a first physical property is used in a structure of the flexure hinge, and
a second material having a second physical property stiffer than the first physical property is used in a rubber structure of the stage.

3. The stage apparatus of claim 1, wherein:
a nylon filament is used in a structure of the flexure hinge, and
a polylactic acid (PLA) filament is used in a rubber structure of the stage.

4. The stage apparatus of claim 1, wherein:
metal or an alloy using at least one of aluminum (Al), titanium (Ti) and copper (Cu) is used in a structure of the flexure hinge, and
metal or an alloy using at least one of magnesium (Mg), iron and steel is used in a rubber structure of the stage.

5. The stage apparatus of claim 1, wherein the flexure hinge is configured in a hinge form comprising a leaf spring and a notch.

6. The stage apparatus of claim 1, wherein the flexure hinge is configured in a hinge form comprising a leaf spring of a nylon filament and a notch of a polylactic acid (PLA) filament.

7. The stage apparatus of claim 1, wherein the 3D printer comprises a printer of a fused deposition modeling (FMD) method capable of outputting different materials.

8. The stage apparatus of claim 1, further comprising a displacement sensor disposed in the external frame, for measuring a displacement for a moving direction of the stage.

9. The stage apparatus of claim 8, wherein the displacement sensor comprises a capacitive sensor disposed in accordance with the piezoelectric actuator.

10. A method of fabricating a multi-degree-of-freedom precision stage, wherein the multi-degree-of-freedom precision stage comprises a flexure hinge configured as a coupling element between an external frame and a stage moving part and a plurality of piezoelectric actuators disposed in the external frame, for moving the stage with a moving degree of freedom in a plurality of directions, and
the method of fabricating the multi-degree-of-freedom precision stage comprises fabricating the stage of a monolithic structure using a multi-material output by a 3D printer by controlling the 3D printer outputting two or more different materials based on a 3D design for the multi-degree-of-freedom precision stage.

11. The method of claim 10, wherein:
a first material having a first physical property is used in a structure of the flexure hinge, and
a second material having a second physical property stiffer than the first physical property is used in a rubber structure of the stage.

12. The method of claim 10, wherein:
a nylon filament is used in a structure of the flexure hinge, and
a polylactic acid (PLA) filament is used in a rubber structure of the stage.

13. The method of claim 10, wherein:
metal or an alloy using at least one of aluminum (Al), titanium (Ti) and copper (Cu) is used in a structure of the flexure hinge, and
metal or an alloy using at least one of magnesium (Mg), iron and steel is used in a rubber structure of the stage.

14. The method of claim 10, wherein the flexure hinge is configured in a hinge form comprising a leaf spring of a nylon filament and a notch of a polylactic acid (PLA) filament.

15. The method of claim 10, wherein the 3D printer comprises a printer of a fused deposition modeling (FMD) method capable of outputting different materials.

16. The method of claim 10, wherein the multi-degree-of-freedom precision stage comprises a displacement sensor disposed in the external frame, for measuring a displacement for a moving direction of the stage.

17. The method of claim 16, wherein the displacement sensor comprises a capacitive sensor disposed in accordance with the piezoelectric actuator.
